(19) United States
(12) Patent Application Publication
(10) Pub. No.: US 2016/0164749 A1
(43) Pub. Date: Jun. 9, 2016

(54) Methods and Systems for Establishing a Centralized Analytics Environment

(71) Applicant: Fractal Analytics, Inc., San Mateo, CA (US)

(72) Inventors: Rasesh Dhirendra Shah, Mumbai (IN); Vishal Kishanchand Rajpal, Mumbai (IN); Sameer Nandakumar Phatak, Mumbai (IN)

(21) Appl. No.: 14/935,073

(22) Filed: Nov. 6, 2015

Related U.S. Application Data
(60) Provisional application No. 62/077,000, filed on Nov. 7, 2014.

(51) Int. Cl. H04L 12/24; H04L 29/08

(52) U.S. Cl. CPC H04L 41/22; H04L 67/10; H04L 41/145

(57) ABSTRACT

A method of establishing a centralized analytics environment includes receiving a plurality of environmental requirements from a user and, based upon the plurality of environmental requirements, establishing at least one recommended technology stack for a centralized analytics environment. The environmental requirements that define the centralized analytics problem can include data format requirements, data volume requirements, data refresh rate requirements, data source requirements, analytics nature requirements, analytics complexity requirements, analytics application requirements, analytics consumption environment requirements, and analytics consumption frequency requirements. The at least one recommended technology stack typically includes a recommended data loading tool, a recommended data transformation tool, a recommended data storage tool, a recommended analytics tool, and a recommended extended data storage tool. It can also include recommended physical and/or virtual hardware infrastructure.

### CROSS-REFERENCE TO RELATED APPLICATIONS

This application claims the benefit of U.S. provisional application No. 62/077,000, filed 7 Nov. 2014, which is hereby incorporated by reference as though fully set forth herein.

### BACKGROUND

The instant disclosure relates to cloud computing. In particular, the instant disclosure relates to methods, apparatuses, and systems for the selection and implementation of a technology stack (e.g., infrastructure and software) for cloud-based services.

Internal structured data is but a small fraction of the data presently available. Indeed, by some estimates, more than 90% of today's data is unstructured (e.g., sensor data, social media data, and the like).

There are many challenges associated with aggregating and making use of this type and volume data. These challenges include selecting from among the multiplicity of cloud-based offerings for, inter alia, ingesting, storing, processing, and visualizing such data.

### BRIEF SUMMARY

Disclosed herein is a method of establishing a centralized analytics environment, including the steps of: receiving, at a processor, a plurality of environmental requirements from a user; and based upon the plurality of environmental requirements received from the user, establishing, via the processor, at least one recommended technology stack for a centralized analytics environment, the at least one recommended technology stack including a recommended data loading tool, a recommended data transformation tool, a recommended data storage tool, a recommended analytics tool, and a recommended extended data storage tool. In embodiments, the plurality of environmental requirements defines a centralized analytics problem and includes: at least one data format requirement; at least one data volume requirement; at least one data refresh rate requirement; at least one data source requirement; at least one analytics nature requirement; at least one analytics complexity requirement; at least one analytics application requirement; at least one analytics consumption environment requirement; and at least one analytics consumption frequency requirement.

The processor can establish a recommended data loading tool for the at least one recommended technology stack based upon the at least one data format requirement, the at least one data volume requirement, and the at least one analytics consumption frequency requirement. It can establish a recommended data transformation tool for the at least one recommended technology stack based upon the at least one data format requirement, the at least one data volume requirement, the at least one analytics consumption frequency requirement, and, optionally, the at least one data source requirement.

The processor can establish a recommended data storage tool for the at least one recommended technology stack based upon the at least one data format requirement, the at least one data volume requirement, and the at least one analytics consumption frequency requirement. It can establish a recommended analytics tool for the at least one recommended technology stack based upon the at least one analytics consumption frequency requirement, the at least one analytics nature requirement, and, optionally, the recommended data storage tool.

It is contemplated that a graphical user interface can be established by which the user can input, and the processor can receive, the plurality of environmental requirements. The graphical user interface can also be used to output the at least one recommended technology stack, which recommendation can also include cost information and recommended hardware infrastructure information. In addition, in certain aspects, the graphical user interface can allow the user to select a recommended technology stack for commissioning, and a centralized analytics environment can be established according to the selected recommended technology stack.

The foregoing and other aspects, features, details, utilities, and advantages of the present invention will be apparent from reading the following description and claims, and from reviewing the accompanying drawings.

### BRIEF DESCRIPTION OF THE DRAWINGS

FIGS. 1-9 are exemplary screen shots of a graphical user interface (“GUI”) for the input of requirements and the output of recommended technology stack(s) according to embodiments of the teachings herein.

### DETAILED DESCRIPTION

The present disclosure provides computer systems and computer-implemented methods useful to develop recommendations for cloud-based service technology stacks (e.g., infrastructure and software). For example, a graphical user interface (“GUI”) can be established that allows a user to input the requirements that define a particular business problem, and the methods disclosed herein can be applied to these inputs to present one or more recommended solutions to the problem defined. For purposes of illustration, the teachings herein will be explained with reference to the establishment of a cloud-based central analytics environment. It should be understood, however, that the instant teachings can likewise be practiced to good advantage in other contexts without departing from the spirit and scope of the present disclosure.

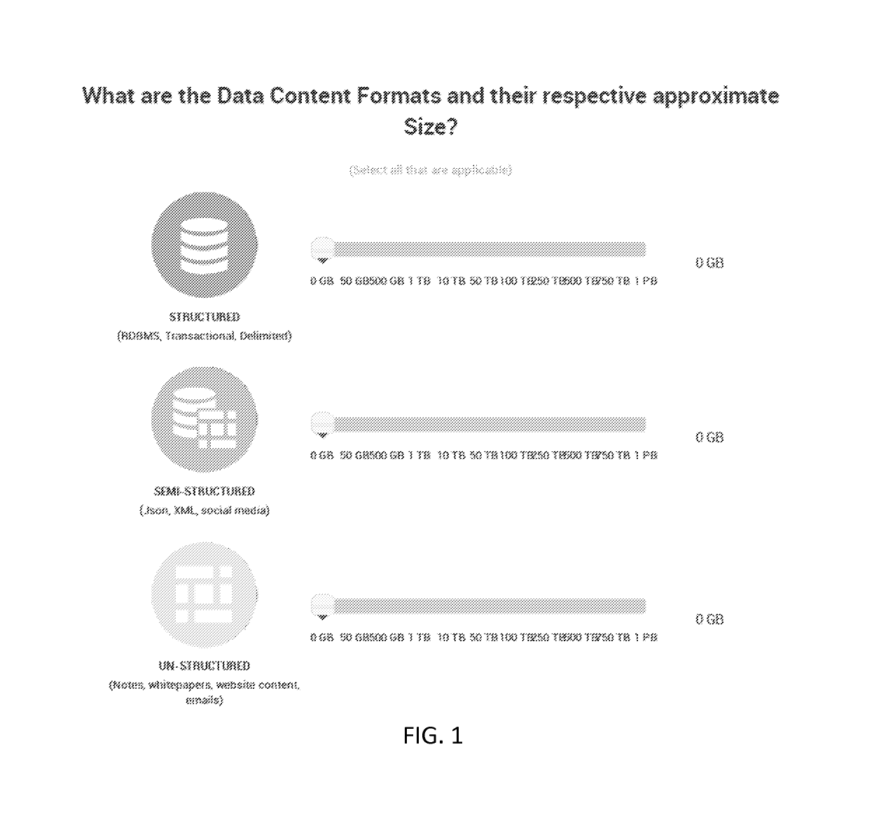

FIGS. 1-9 are screen shots of a representative GUI according to the teachings herein. The ordinarily skilled artisan will appreciate, however, that the screen shots depicted and described herein are merely representative, and that their design in a particular embodiment could differ without departing from the spirit and scope of the instant disclosure.

Put another way, FIGS. 1-9 depict a representative GUI through which a user can input a plurality of environmental requirements. FIG. 1, for example, shows a portion of the GUI that can be used to input one or more data format and data volume requirements. In certain embodiments, all data can be characterized as either structured (e.g., RDBMS, transactional, delimited), semi-structured (e.g., Json, XML, social media), or unstructured (e.g., notes, whitepapers, website content, emails). Slider bars can be provided to allow the user to set the relative volumes of each data format.

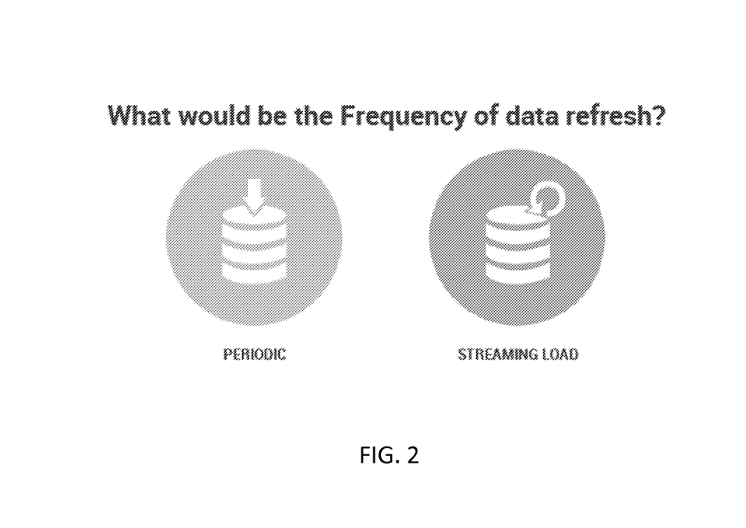

FIG. 2 shows a portion of the GUI that can be used to input one or more data refresh rate requirements. Thus, as shown in FIG. 2, in certain aspects, the data is either refreshed periodically (e.g., in discrete chunks) or via streaming (e.g., more-or-less continuously).

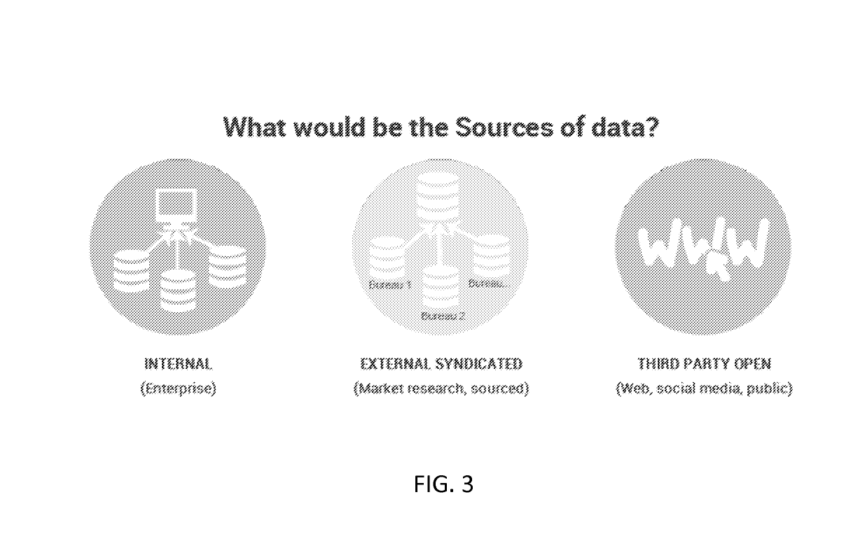

FIG. 3 shows a portion of the GUI that can be used to input one or more data source requirements. In embodiments, the data sources are characterized as either internal (e.g., enterprise data), external syndicated (e.g., market research data, sourced data), or third party open (e.g., web data, social media data, public data).

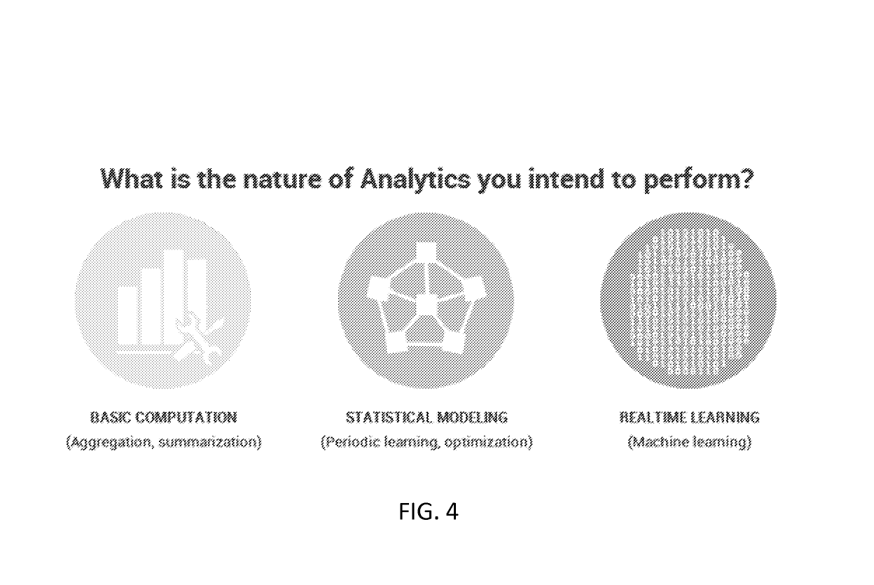

FIG. 4 shows a portion of the GUI that can be used to input one or more analytics nature requirements. For example, in embodiments, the analytics can be characterized as either basic computation (e.g., aggregation, summarization), statistical modeling (e.g., periodic learning, optimization), or real-time learning (e.g., machine learning).

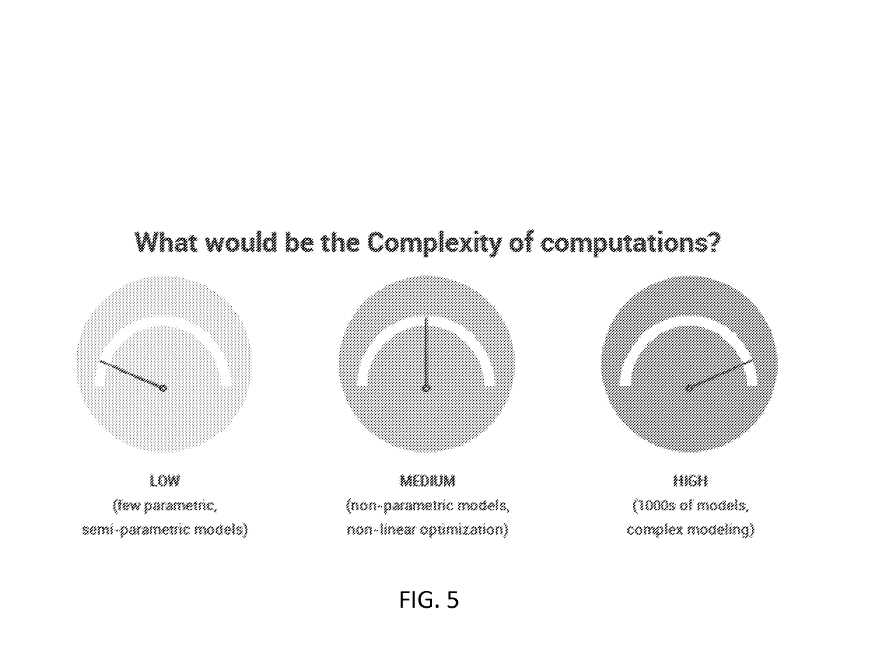

FIG. 5 shows a portion of the GUI that can be used to input one or more analytics complexity requirements. For example, in embodiments, the computations can be characterized as either of low complexity (e.g., few parametric/semi-parametric models), medium complexity (e.g., non-parametric models and/or non-linear optimizations), or high complexity (e.g., thousands of models and/or complex modeling).

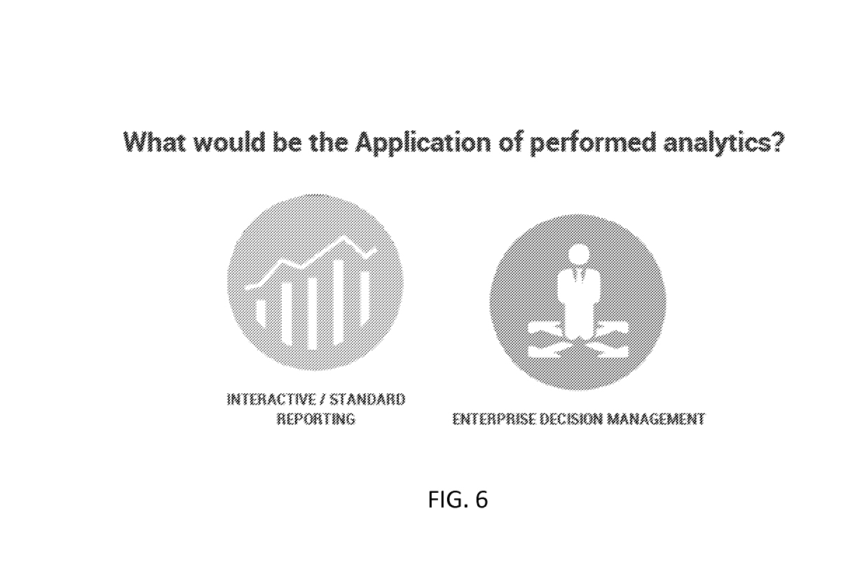

As shown in FIG. 6, one or more analytics application requirements can also be defined. For example, in certain aspects of the disclosure, analytics can be applied for interactive/standard reporting or for enterprise decision management.

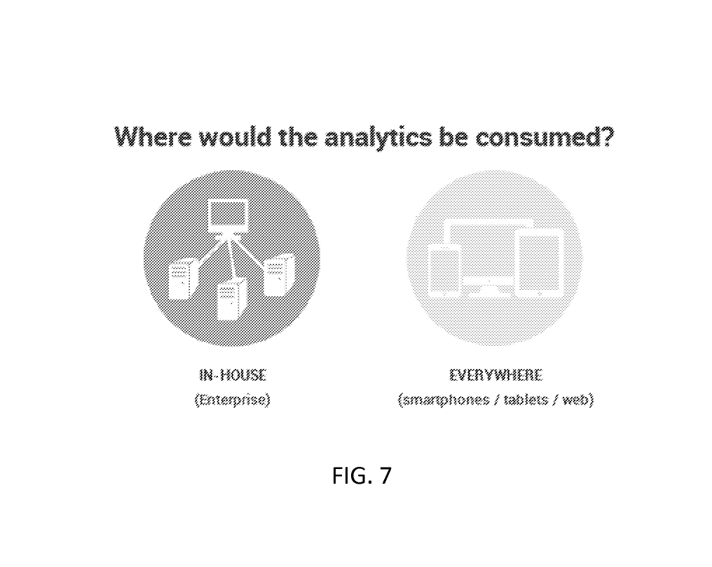

FIG. 7 illustrates a portion of the GUI that can be used to define requirements related to the environment within which analytics will be consumed (e.g., in-house/enterprise or “everywhere” (including mobile)).

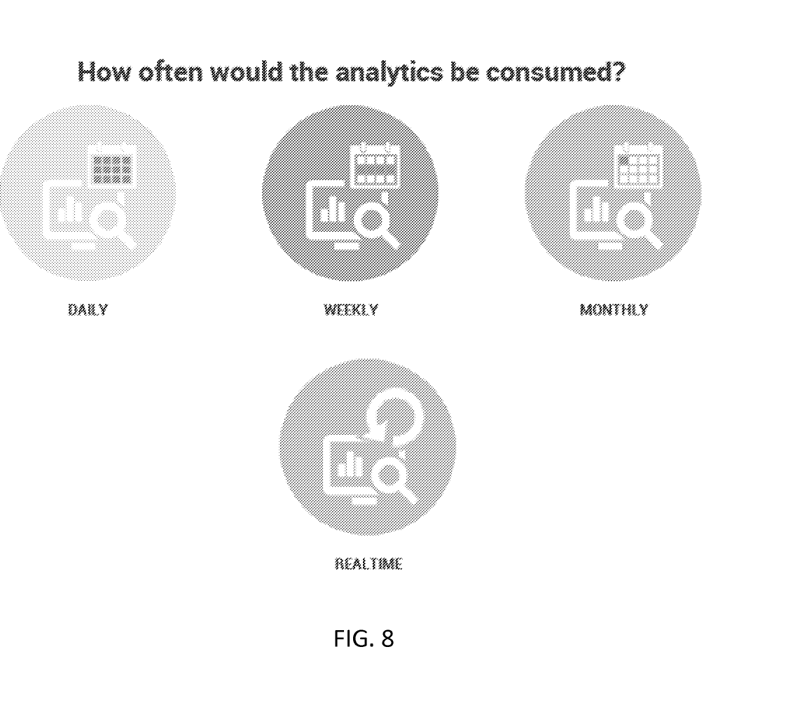

FIG. 8 depicts an aspect of the GUI usable to define requirements related to the frequency with which analytics will be consumed. For example, as shown in FIG. 8, analytics can be consumed daily, weekly, monthly, or in real-time.

Once all of the requirements have been input, various algorithms can be applied to establish one or more recommended technology stacks (e.g., collections of infrastructure and software) suitable for a centralized analytics environment defined by the input requirements. According to aspects of the disclosure, each recommended technology stack can include a recommended data loading tool, a recommended data transformation tool, a recommended data storage tool, a recommended analytics tool, and a recommended extended data storage tool. For example, the Appendix to this disclosure sets forth one suitable algorithm for the establishment of recommended technology stacks for a centralized analytics environment given certain inputs that define a centralized analytics problem.

The ordinarily skilled artisan will appreciate that the various tools discussed above are software tools. It is contemplated, however, that the recommended technology stack(s) can also include recommended infrastructure (e.g., machine size and number of machines in a clustered environment). It should be understood that the recommended infrastructure can be physical, virtual, or a combination of physical and virtual.

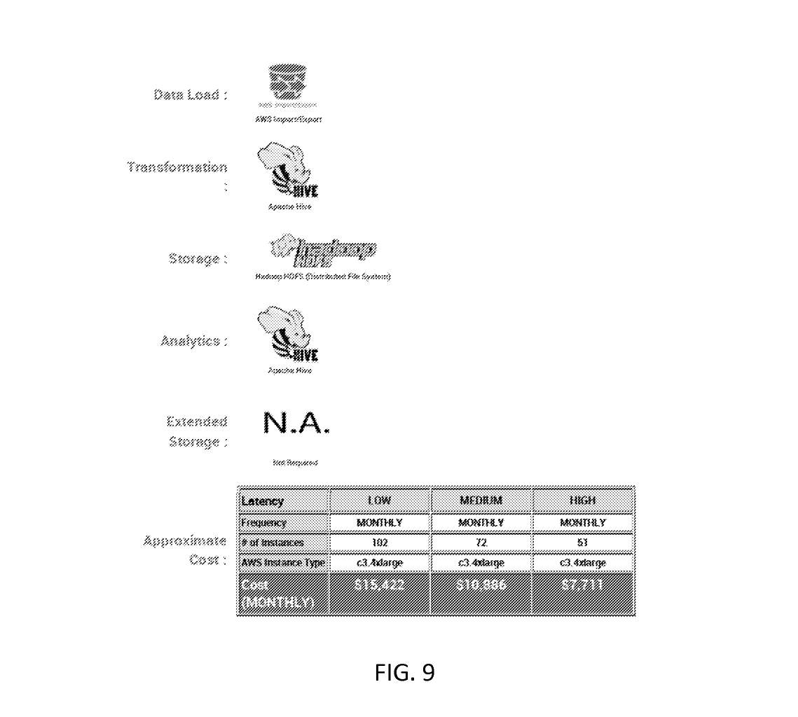

The recommended technology stack(s) can also be presented to the user graphically. For example, FIG. 9 shows one exemplary presentation of recommended technology stacks. It also illustrates that the output can include cost information for the recommended stack(s). Each recommended stack can also include a button or other interface that, when actuated, will begin the process of provisioning the selected recommended technology stack.

For the sake of illustration, the technology stacks shown in FIG. 9 correspond to the following input requirements:
Data Format: Unstructured;
Data Volume: 501 GB to 1 TB;
Data Refresh Rate: One Time Load;
Data Source: Internal;
Analytics Nature: Basic Summarization;
Analytics Complexity: Medium;
Analytics Application: Interactive/Standard Reporting;
Analytics Consumption Environment: In House; and
Analytics Consumption Frequency: Weekly.

The ordinarily skilled artisan will appreciate that the suitable technology stack (e.g., infrastructure and software) will vary depending on the requirements input through the GUI as described above. It will further be understood that, as a result of the multiplicity of options

Although several embodiments of this invention have been described above with a certain degree of particularity, those skilled in the art could make numerous alterations to the disclosed embodiments without departing from the spirit or scope of this invention.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

1. A method of establishing a centralized analytics environment, comprising:
receiving, at a processor, a plurality of environmental requirements from a user; and
based upon the plurality of environmental requirements received from the user, establishing, via the processor, at least one recommended technology stack for a centralized analytics environment, the at least one recommended technology stack including a recommended data loading tool, a recommended data transformation tool, a recommended data storage tool, a recommended analytics tool, and a recommended extended data storage tool.

2. The method according to claim 1, wherein the plurality of environmental requirements comprises:
at least one data format requirement;
at least one data volume requirement;
at least one data refresh rate requirement;
at least one data source requirement;
at least one analytics nature requirement;
at least one analytics complexity requirement;
at least one analytics application requirement;
at least one analytics consumption environment requirement; and
at least one analytics consumption frequency requirement.

3. The method according to claim 2, wherein establishing, via the processor, at least one recommended technology stack comprises establishing, via the processor, a recommended data loading tool for the at least one recommended technology stack based upon the at least one data format requirement, the at least one data volume requirement, and the at least one analytics consumption frequency requirement.

4. The method according to claim 2, wherein establishing, via the processor, at least one recommended technology stack comprises establishing, via the processor, a recommended data transformation tool for the at least one recommended technology stack based upon the at least one data format requirement, the at least one data volume requirement, and the at least one analytics consumption frequency requirement.

5. The method according to claim 4, wherein the recommended data transformation tool for the at least one recommended technology stack is further based upon the at least one data source requirement.

6. The method according to claim 2, wherein establishing, via the processor, at least one recommended technology stack comprises establishing, via the processor, a recommended data storage tool for the at least one recommended technology stack based upon the at least one data format requirement, the at least one data volume requirement, and the at least one analytics consumption frequency requirement.

7. The method according to claim 2, wherein establishing, via the processor, at least one recommended technology stack comprises establishing, via the processor, a recommended analytics tool for the at least one recommended technology stack based upon the at least one analytics consumption frequency requirement and the at least one analytics nature requirement.

8. The method according to claim 7, wherein the recommended analytics tool for the at least one recommended technology stack is further based upon the recommended data storage tool.

9. The method according to claim 1, further comprising establishing, via the processor, a graphical user interface configured to receive the plurality of environmental requirements.

10. The method according to claim 7, wherein the graphical user interface further comprises cost information for the at least one recommended technology stack.

11. The method according to claim 1, further comprising establishing a centralized analytics environment according to the at least one recommended technology stack upon receipt by the processor of user selection of the at least one recommended technology stack for commissioning.

12. The method according to claim 1, wherein the plurality of environmental requirements defines a centralized analytics problem.

13. The method according to claim 1, wherein the at least one recommended technology stack further comprises a recommended hardware infrastructure.

14. A system for establishing a centralized analytics environment, comprising:
a graphical user interface configured to receive as input a plurality of environmental requirements; and
a processor configured:
to analyze the plurality of environmental requirements; and
to establish at least one recommended technology stack for a centralized analytics environment,
wherein the at least one recommended technology stack includes a recommended data loading tool, a recommended data transformation tool, a recommended data storage tool, a recommended analytics tool, and a recommended data storage tool.

15. The system according to claim 14, wherein the plurality of environmental requirements comprises:
at least one data format requirement;
at least one data volume requirement;
at least one data refresh rate requirement;
at least one data source requirement;
at least one analytics nature requirement;
at least one analytics complexity requirement;
at least one analytics application requirement;
at least one analytics consumption environment requirement; and
at least one analytics consumption frequency requirement.

16. The system according to claim 15, wherein the processor is configured to establish the recommended data loading tool, the recommended data transformation tool, and the recommended data storage tool based upon the at least one data format requirement, the at least one data volume requirement, and the at least one analytics consumption frequency requirement.

17. The system according to claim 16, wherein the processor is further configured to establish the recommended data transformation tool based upon the at least one data source requirement.

18. The system according to claim 15, wherein the processor is configured to establish the recommended analytics tool based upon the at least one analytics consumption frequency requirement and the at least one analytics nature requirement.

19. The system according to claim 14, wherein the at least one recommended technology stack further comprises a recommended hardware infrastructure.

20. The system according to claim 14, wherein the processor is further configured to determine cost information for the at least one recommended technology stack.
